(19) United States
(12) Patent Application Publication
(10) Pub. No.: US 2025/0038555 A1
(43) Pub. Date: Jan. 30, 2025

(54) CHARGING CIRCUIT INCLUDING SWITCHING CONVERTER, AND ELECTRONIC DEVICE INCLUDING THE SAME

(71) Applicant: Samsung Electronics Co., Ltd., Suwon-si (KR)

(72) Inventors: Sungwoo LEE, Suwon-si (KR); Jaekyu KIM, Suwon-si (KR); Sungwoo MOON, Suwon-si (KR); Daewoong CHO, Suwon-si (KR); Jungwook HEO, Suwon-si (KR)

(73) Assignee: Samsung Electronics Co., Ltd., Suwon-si (KR)

(21) Appl. No.: 18/753,373

(22) Filed: Jun. 25, 2024

(30) Foreign Application Priority Data
Jul. 28, 2023 (KR) 10-2023-0099001
Nov. 16, 2023 (KR) 10-2023-0159287

(51) Int. Cl. H02J 7/00; H02J 50/10; H02M 3/158; H04R 1/10

(52) U.S. Cl. CPC H02J 7/00712; H02J 7/0044; H02J 50/10; H02M 3/1582; H04R 1/1016; H04R 1/1025; H02J 2207/20; H04R 2420/07

(57) ABSTRACT

A charging circuit may include a buck-boost circuit and a voltage regulator circuit, wherein the buck-boost circuit converts a first input voltage received at a first node into a first output voltage and charges a battery based on the first output voltage, and time-divisionally converts a second input voltage provided from the battery into a second output voltage provided to a first external device and a third output voltage provided to a second external device, and the voltage regulator circuit adjusts the first input voltage to generate the second output voltage and the third output voltage.

### CROSS-REFERENCE TO RELATED APPLICATION

This application is based on and claims priority under 35 U.S.C. § 119 to Korean Patent Application Nos. 10-2023-0099001, filed on Jul. 28, 2023, and 10-2023-0159287, filed on Nov. 16, 2023, in the Korean Intellectual Property Office, the disclosures of each of which are incorporated by reference herein in their entireties.

### BACKGROUND

Inventive concepts relate to a switching converter, and more particularly, to a charging circuit including a switching converter having a single forward output and multiple reverse outputs using a single inductor, and an electronic device including the same.

Mobile electronic devices use rechargeable batteries as a power supply to provide the advantage of mobility. The capacity of the battery of a mobile electronic device is limited, and users must properly charge the battery before the battery runs out. A charger (e.g. travel adapter) that enables charging a battery converts power supplied from AC 110 V˜220 V, a household power source, or other power supply means (e.g., computers), into DC power required for charging the battery and provides the DC power to mobile electronic devices. The mobile electronic devices may use DC power converted from a charging circuit to charge a battery. Additionally, a mobile electronic device may charge other mobile electronic devices using the battery of the mobile electronic device. In order to improve the usage time and charging performance of mobile electronic devices, a charging circuit with high (or improved) charging efficiency is required (or beneficial).

### SUMMARY

Some example embodiments of inventive concepts provide a charging circuit that generates a single output in the forward direction and multiple outputs in the reverse direction using a single inductor, and has high charging efficiency.

Some example embodiments of inventive concepts provide a charging circuit including a buck-boost circuit configured to convert a first input voltage received at a first node into a first output voltage to charge a battery based on the first output voltage, and time-divisionally convert a second input voltage provided from the battery into a second output voltage provided to a first external device and a third output voltage provided to a second external device, and a voltage regulator circuit configured to adjust the first input voltage to generate a fourth output voltage and a fifth output voltage. The voltage regulator circuit is configured to provide the fourth output voltage to the first external device and the fifth output voltage to the second external device in response to the charging circuit operating in a first power mode and the buck-boost converter circuit is configured to provide the second output voltage to the first external device and the third output voltage to the second external device in response to the charging circuit operating in a second power mode.

Some example embodiments of inventive concepts provide an electronic device including a battery, and a charging circuit configured to charge at least one of the battery and a plurality of external devices based on a first input voltage received from outside, and the charging circuit is further configured to charge the plurality of external devices based on a second input voltage from the batter, wherein the charging circuit includes a switching converter circuit configured to generate a plurality of output voltages using a single inductor, convert the first input voltage into a first output voltage provided to the battery in a first power mode, and convert the second input voltage from the battery into a second output voltage and a third output voltage provided to each of a first external device and a second external device, respectively, in a second power mode, and a voltage regulator circuit configured to adjust the first input voltage in the first power mode to generate a fourth output voltage and a fifth output voltage. The voltage regulator circuit is configured to provide the fourth output voltage and the fifth output voltage to the second external device in response to the charging circuit operating in the first power mode.

Some example embodiments of inventive concepts provide a method of operating an electronic device including a battery and a charging circuit for charging the battery including detecting whether there is an external input power received from outside, operating in a first power mode based on the external input power when the external input power is provided, and operating in a second power mode based on internal input power provided from the battery when the external input power is not provided, wherein, in the first power mode, a buck-boost converter circuit provided in the charging circuit is configured to generate a first output voltage provided to the battery based on the external input power, and a voltage regulator circuit provided in the charging circuit is configured to generate a fourth output voltage and a fifth output voltage provided to a first external device and a second external device, respectively, based on the external input power, and wherein, in the second power mode, the buck-boost converter circuit is configured to generate the second output voltage and the third output voltage based on the internal input power.

### BRIEF DESCRIPTION OF THE DRAWINGS

Some example embodiments of inventive concepts will be more clearly understood from the following detailed description taken in conjunction with the accompanying drawings in which:

FIG. 1 shows a charging circuit and an electronic device including the same according to an example embodiment;

FIG. 2 is a block diagram showing a charging circuit according to an example embodiment;

FIG. 3 is a circuit diagram showing a charging circuit according to an example embodiment;

FIG. 4 shows a charging circuit according to an example embodiment operating in a first power mode;

FIGS. 5A and 5B show forward buck-boost operation of the switching converter;

FIG. 6 is a timing diagram of control signals and inductor current when a switching converter performs forward buck-boost operation;

FIG. 7 shows a charging circuit according to an example embodiment operating in a second power mode;

FIGS. 8A, 8B, and 8C show reverse buck-boost operation of the switching converter;

FIG. 9 is a timing diagram of control signals and inductor current when the switching converter performs a forward buck-boost operation;

FIG. 10 is a circuit diagram showing a charging circuit according to an example embodiment;

FIG. 11 is a circuit diagram showing a charging circuit according to an example embodiment;

FIG. 12 is a circuit diagram showing a charging circuit according to an example embodiment;

FIG. 13 shows a charging circuit and an electronic device including the same according to an example embodiment;

FIG. 14 is a circuit diagram showing a charging circuit according to an example embodiment;

FIG. 15 is a flowchart showing a method of operating an electronic device including a charging circuit according to an example embodiment;

FIG. 16 is a block diagram showing an electronic device according to an example embodiment; and

FIG. 17 is a diagram illustrating an electronic system according to an example embodiment.

### DETAILED DESCRIPTION OF THE EMBODIMENTS

Hereinafter, some example embodiments of inventive concepts are described in detail with reference to the attached drawings.

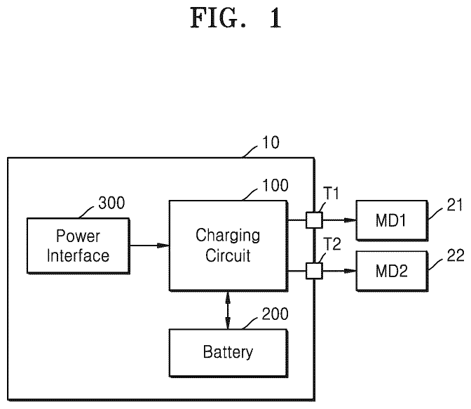

FIG. 1 shows a charging circuit and an electronic device including the same according to an example embodiment. In FIG. 1, a first mobile device 21 and a second mobile device 22 connected to an electronic device 10 are shown together.

Referring to FIG. 1, the electronic device 10 may include a charging circuit 100, a battery 200, and a power interface 300. In addition, the electronic device 10 may further include general-purpose components, such as a processor, communication circuit, and display.

In some example embodiments, the electronic device 10 may be a mobile device. For example, the electronic device 10 may be a charging case or cradle. However, the electronic device 10 is not limited thereto, and the electronic device 10 may be one of a variety of devices that include the battery 200 or that have removable battery, such as a smartphone, tablet personal computer, laptop personal computer, or wearable device.

The charging circuit 100 according to some example embodiments may charge the battery 200 and also charge external devices, such as the first mobile device 21 and the second mobile device 22. The charging circuit 100 may also provide system voltage utilized within the electronic device 10.

In some example embodiments, the first mobile device 21 and the second mobile device 22 may be wireless earphones or earbuds. For example, the first mobile device 21 may be the left earbud of a pair of earbuds, and the second mobile device 22 may be the right earbud of a pair of earbuds. However, the first mobile device 21 and the second mobile device 22 are not limited thereto, and the first mobile device 21 and the second mobile device 22 may be one of various devices equipped with a battery, such as wearable devices such as smart glasses, smart watches, and smart bands, mobile medical devices, and cameras, but example embodiments are not limited thereto.

In some example embodiments, when external power (e.g., external power voltage) is received from an external device (e.g., a device separate from the electronic device (10 in FIG. 1)) through the power interface 300, the charging circuit 100 may operate in the first power mode (also referred to as external power mode). In the first power mode, the charging circuit 100 may charge the battery 200 and/or the first mobile device 21 and the second mobile device 22 based on an external power source. For example, the charging circuit 100 may perform bucking of the external power voltage to generate a charging voltage provided to the battery 200, for example, a first output voltage. The first output voltage may be provided to other components within the electronic device 10 as well as the battery 200.

The charging circuit 100 may also perform bucking of an external power supply voltage in the first power mode to generate charging voltages, such as a second output voltage and a third output voltage (or alternatively referred to as a fourth output voltage and a fifth output voltage), provided to the first mobile device 21 and the second mobile device 22, respectively. The first mobile device 21 and the second mobile device 22 may be connected to the electronic device 10 through the first output terminal T1 and the second output terminal T2, respectively. The second output voltage and the third output voltage (or the fourth output voltage and the fifth output voltage) may be provided to the first mobile device 21 and the second mobile device 22, respectively, through the first output terminal T1 and the second output terminal T2. In an example embodiment, the first output terminal T1 and the second output terminal T2 may be implemented with POGO pins.

Hereinafter, the charging circuit 100 is described as an example of generating charging voltages, for example, a second output voltage and a third output voltage, respectively, (or a fourth output voltage and a fifth output voltage, respectively,) provided to the first mobile device 21 and the second mobile device 22. However, the charging circuit 100 is not limited thereto and may generate three or more charging voltages that are respectively provided to three or more mobile devices.

In some example embodiments, when external power is not received from an external device, the charging circuit 100 may operate in the second power mode (or referred to as internal power mode). In the second power mode, the charging circuit 100 may charge the first mobile device 21 and the second mobile device 22 based on internal power (e.g., internal power voltage) provided from the battery 200. For example, the charging circuit 100 may perform bucking (step-down) or boosting (step-up) of the internal power voltage to generate a second output voltage and a third output voltage provided to the first mobile device 21 and the second mobile device 22, respectively.

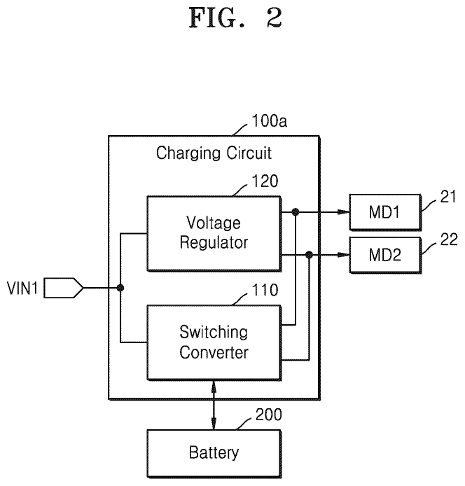

In some example embodiments, the charging circuit 100 may include a switching converter (e.g., 110 in FIG. 2) with a single inductor multi-output, as described below with reference to FIGS. 2 to 13. The switching converter 110 may generate a first output voltage provided to the battery 200 by performing a buck-boost operation on an external power voltage in the first direction (e.g., forward direction) based on the external power voltage in the first power mode and may perform a buck-boost operation on an internal power voltage in the second direction (e.g., reverse direction) based on the internal power voltage provided from the battery 200 in the second power mode to generate a second output voltage and a third output voltage provided to the first mobile device 21 and the second mobile device 22, respectively. In the present specification, the first direction (e.g., forward direction) refers to the direction in which the current of the inductor provided in the charging circuit 100 flows to the battery 200, and the second direction (e.g., reverse direction) refers to the direction in which the current output from the battery 200 flows into the inductor.

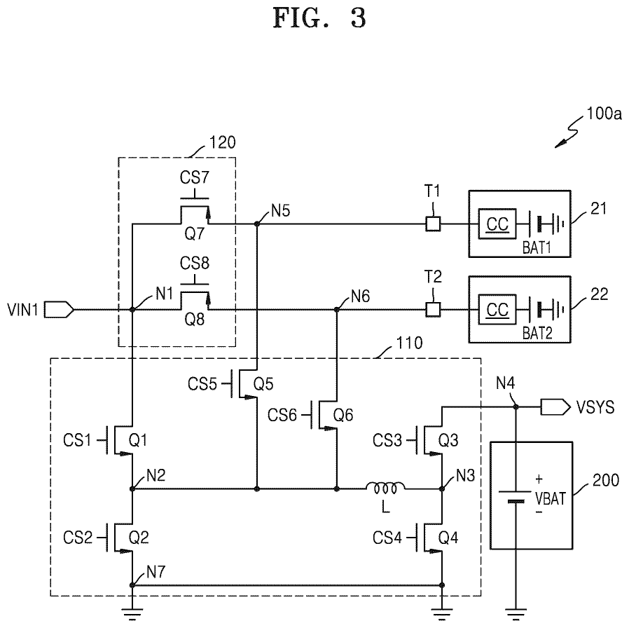

The charging circuit 100 may generate the second output voltage and the third output voltage in a time-division manner using a single inductor (e.g., inductor L in FIG. 3) in the second power mode. Accordingly, the charging circuit 100 may independently control (or may control) the first mobile device 21 and the second mobile device 22 regardless of the voltage level of the internal power voltage provided from the battery 200. For example, the charging circuit 100 may generate different second and third output voltages and charge the first mobile device 21 and the second mobile device 22 based on the different second and third output voltages. Accordingly, the charging efficiency of the charging circuit 100 may be improved while minimizing (or reducing) the increase in bill of material (BOM). The configuration and operation of the charging circuit 100 are described in detail below with reference to FIGS. 2 to 14.

The charging circuit 100 may be referred to as a “charging integrated circuit,” “battery charger,” or “power management integrated circuit (PMIC).” The charging circuit 100 may be implemented in various forms and, for example, may be implemented with one or more semiconductor devices (or semiconductor chips, semiconductor packages, etc.). According to some example embodiments, the charging circuit 100 may include a voltage regulator (120 in FIG. 2) and a switching converter (110 in FIG. 2), and when the charging circuit 100 is implemented as a semiconductor chip, various circuits included in the voltage regulator (120 in FIG. 2) and the switching converter (110 in FIG. 2) may be formed on one (or the same) semiconductor substrate. In addition, circuits included in the voltage regulator (120 in FIG. 2) and the switching converter (110 in FIG. 2) may be formed on the same semiconductor substrate and using the same semiconductor process.

In some example embodiments, the charging circuit 100 may be mounted on a board (e.g., a printed circuit board) within the electronic device 10. One or more circuit elements related to the charging operation, such as an inductor and capacitor, are disposed on the board, and the charging circuit 100 may be connected to the one or more circuit elements.

In some example embodiments, the charging circuit 100 may be formed of a semiconductor chip, on which some or all of the circuits are formed, and a passive element (e.g., an inductor). The semiconductor chip and the passive element may be placed on a board in the electronic device 10 and electrically connected to each other.

The battery 200 may be built into the electronic device 10 or may be removable from the electronic device 10. In some example embodiments, the battery 200 may include a plurality of battery devices (or a plurality of battery cells), and the plurality of battery devices may be connected in series or parallel. In an example embodiment, the battery 200 may be implemented with a battery pack.

The power interface 300 may receive external power from an external device. The power interface 300 may include a wired power reception circuit and/or a wireless power reception circuit. For example, the wired power reception circuit and/or the wireless power reception circuit may include a rectifier, a regulator, etc.

For example, the power interface 300 may be implemented as a wired power interface and may receive external power from a travel adapter (TA) or an auxiliary battery device. The TA may convert power supplied from AC 110 V to 220 V, which is a household power source, or another power supply means (e.g., a computer) into DC power required (or used) for charging the battery 200 and may provide the DC power to the electronic device 10.

For example, the power interface 300 may be implemented as a wireless power interface and may convert a signal received from a wireless power transmission device (e.g., a wireless charging pad) into a specific voltage, for example, an external power supply voltage.

FIG. 2 is a block diagram showing a charging circuit according to an example embodiment.

In FIG. 2, a battery 200, a first mobile device 21, and a second mobile device 22 connected to a charging circuit 100a are shown together. The charging circuit 100a may be applied to the charging circuit 100 of FIG. 1, and therefore, the description of the charging circuit 100 with reference to FIG. 1 may be applied to the charging circuit 100a of FIG. 2.

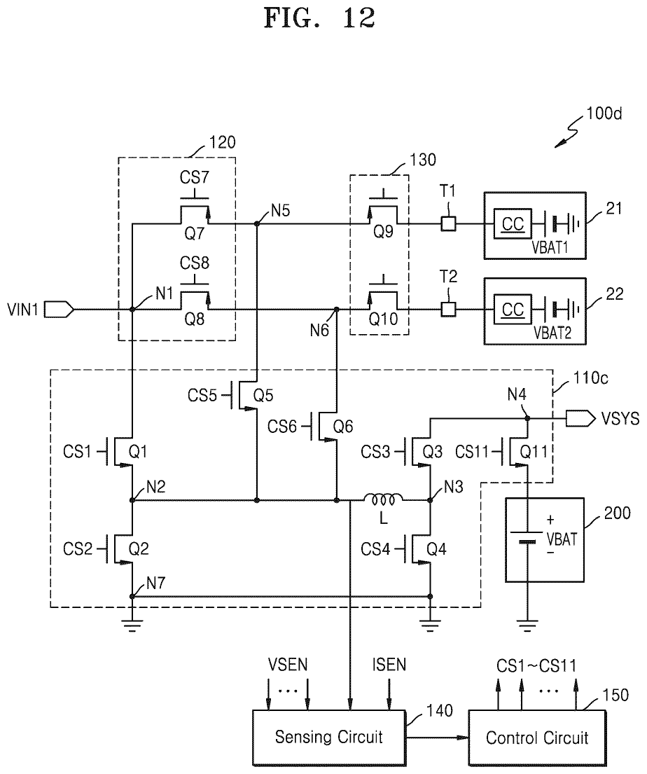

Referring to FIG. 2, the charging circuit 100a may include a switching converter 110 (or a switching converter circuit), a voltage regulator 120 (or a voltage regulator circuit). In some example embodiments, the charging circuit 100a may further include a sensing circuit and an input circuit. In some example embodiments, the charging circuit 100a may further include a control circuit (e.g., 150 in FIG. 12) that provides control signals to the switching converter 110 and the voltage regulator 120.

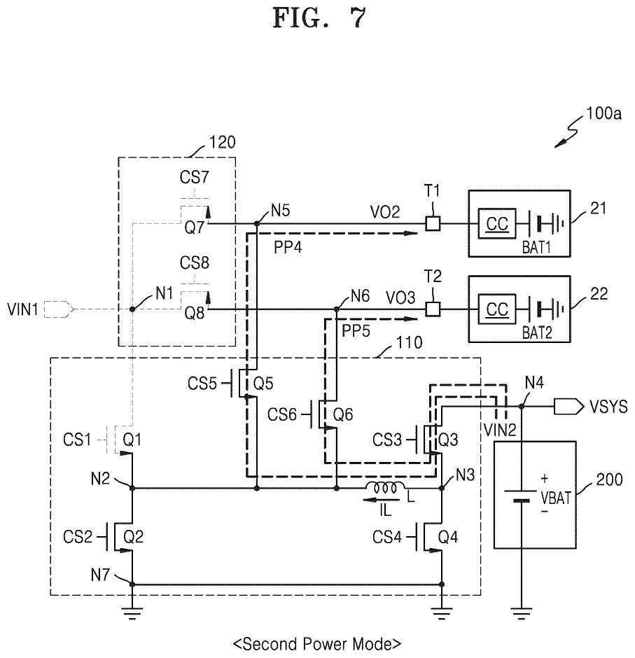

The switching converter 110 may charge the battery 200 based on the first input voltage VIN1 in the first power mode and may charge the first mobile device 21 and the second mobile device 22 based on the second input voltage (e.g., VIN2 in FIG. 7) provided from the battery 200 in the second power mode. The first input voltage VIN1 is an external power voltage provided from an external device, and the second input voltage VIN2 may be an internal power voltage provided from the battery 200, for example, the battery voltage VBAT.

The switching converter 110 may operate in a first power mode and a second power mode. In an example embodiment, the switching converter 110 may be implemented with a DC-DC converter, for example, with a buck-boost converter. In an example embodiment, the switching converter 110 may include a single inductor and may perform a buck-boost operation on input voltages using the single inductor to generate a plurality of output voltages.

The switching converter 110 generates a first output voltage by bucking or boosting the first input voltage VIN1 using a single inductor in the first power mode and provides the first output voltage to the battery 200. Accordingly, the battery 200 may be charged and the battery voltage VBAT may increase to the first output voltage.

The switching converter 110 may generate a second output voltage and a third output voltage in a time-division manner by bucking or boosting the second input voltage provided from the battery 200 using a single inductor in the second power mode and may provide a second output voltage and a third output voltage to the first mobile device 21 and the second mobile device 22, respectively. Accordingly, the switching converter 110 may independently control charging of the first mobile device 21 and charging of the second mobile device 22.

For example, a voltage higher than the second input voltage (e.g., battery voltage) may be required (or used, or beneficial) to charge the first mobile device 21, and a voltage lower than the second input voltage may be required (or used, or beneficial) to charge the second mobile device 22. The switching converter 110 may boost the second input voltage to generate a second output voltage higher than the second input voltage and provide the second output voltage to the first mobile device 21. The switching converter 110 may perform bucking of the second input voltage to generate a third output voltage that is lower than the second input voltage and provide the third output voltage to the second mobile device 22.

The voltage regulator 120 may operate in a first power mode and may be blocked in operation in a second power mode. The voltage regulator 120 generates the second output voltage and the third output voltage (or the fourth output voltage and the fifth output voltage) by bucking (or regulating) the first input voltage VIN1 and may provide a second output voltage and a third output voltage (or the fourth output voltage and fifth output voltage) to the first mobile device 21 and the second mobile device 22, respectively. In an example embodiment, the voltage regulator 120 may be implemented with a low drop-output (LDO). In the second power mode, there is no external power received from the outside, and the switching converter 110 provides the second and third output voltages (or the fourth and fifth output voltages) to the first mobile device 21 and the second mobile device 22, respectively, so the voltage regulator 120 does not operate.

FIG. 3 is a circuit diagram showing a charging circuit according to an example embodiment.

Referring to FIG. 3, the charging circuit 100a includes a switching converter 110 and a voltage regulator 120. The charging circuit 100a of FIG. 3 may be applied to the charging circuit 100 of FIG. 1, and descriptions of the charging circuit 100 of FIG. 1 and the charging circuit 100a of FIG. 2 may be applied to the charging circuit 100a of FIG. 3.

The switching converter 110 may include an inductor L and a plurality of switching elements, for example, first to sixth transistors Q1 to Q6. The switching converter 110 may be implemented with a buck-boost circuit. The first to sixth transistors may be implemented with a P-channel metal oxide semiconductor field effect transistor (MOSFET) or an N-channel MOSFET. However, the switching converter 110 is not limited thereto, and the plurality of switching elements may be implemented as complementary metal-oxide-semiconductor (CMOS) transistors or transmission gates.

The first transistor Q1 may be connected between the first node N1 where the first input voltage VIN1 is received and the second node N2 and may be turned on or off in response to the first control signal CS1. The second transistor Q2 may be connected between the second node N2 and the seventh node N7 and may be turned on or off in response to the second control signal CS2. A power supply voltage, for example, a ground voltage, may be applied to the seventh node N7. The inductor L may be connected between the second node N2 and the third node N3. The third transistor Q1 may be connected between the third node N3 and the fourth node N4 and may be turned on or off in response to the third control signal CS3. The fourth transistor Q4 may be connected between the third node N3 and the seventh node N7. The fifth transistor Q5 may be connected between the second node N2 and the fifth node N5 and may be turned on or off in response to the fifth control signal CS5. The sixth transistor Q6 may be connected between the second node N2 and the sixth node N56 and may be turned on or off in response to the sixth control signal CS6.

The voltage regulator 120 may include two power transmission elements, for example, a seventh transistor Q7 and an eighth transistor Q8. The seventh transistor Q7 and the eighth transistor Q8 may be implemented with a P-channel MOSFET or an N-channel MOSFET. The seventh transistor Q7 and the eighth transistor Q8 may each operate as an LDO regulator. The seventh transistor Q7 and the eighth transistor Q8 may operate in response to the seventh control signal CS7 and the eighth control signal CS8, respectively.

Furthermore, the charging circuit 100a may further include a control circuit (for example, 150 in FIG. 12), and the control circuit may provide control signals, for example, first to sixth control signals CS1 to CS6, to the switching converter 110 and seventh and eighth control signals CS7 and CS8 to the voltage regulator 120.

The first mobile device 21 and the second mobile device 22 may each include a battery (e.g., a first battery BAT1 and a second battery BAT2), and a charging circuit CC. The charging circuit CC provided in the first mobile device 21 and the second mobile device 22 may charge the battery based on the voltage and current provided from the charging circuit 100a, for example, may charge the battery using a constant current-constant voltage method.

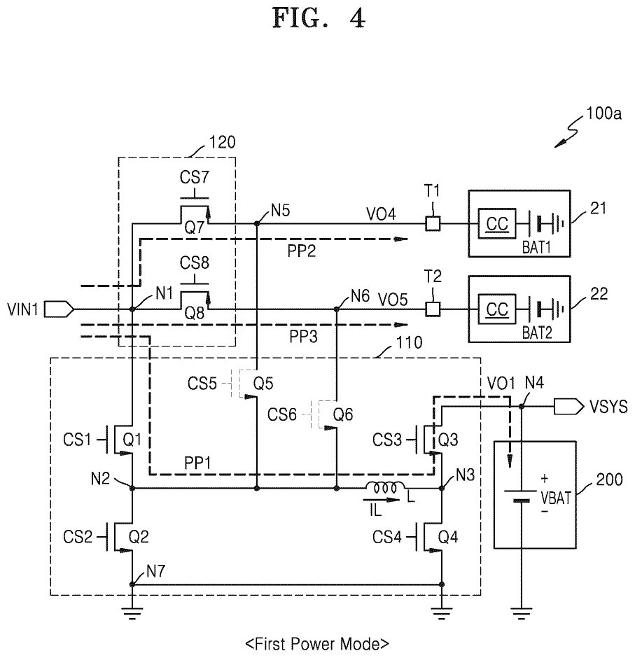

FIG. 4 shows a charging circuit according to an example embodiment operating in a first power mode.

Referring to FIG. 4, when an external power source, for example, the first input voltage VIN1, is applied from the outside, the charging circuit 100a may operate in the first power mode.

The first to fourth transistors Q1 to Q4 provided in the switching converter 110 may perform a switching operation in response to the first to fourth control signals CS1 to CS4, thereby forming a first power path PP1 that provides power to the battery 200 from the first input voltage VIN1. In the first power mode, the fifth transistor Q5 and the sixth transistor Q6 may be turned off.

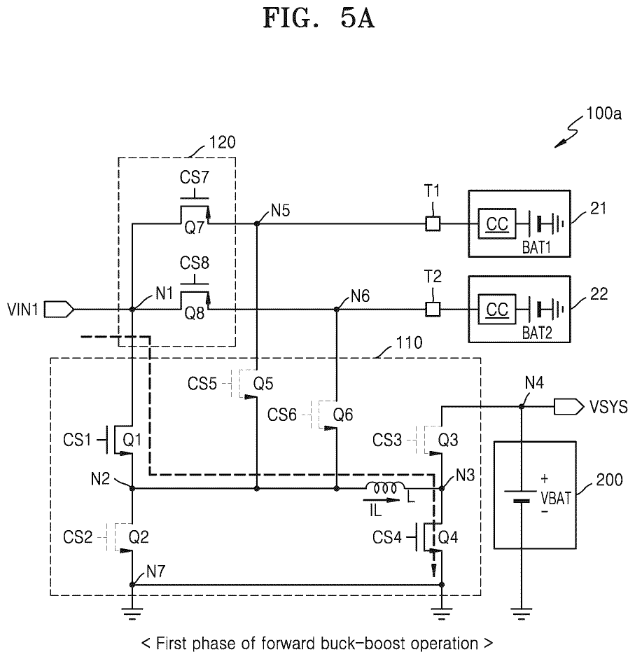

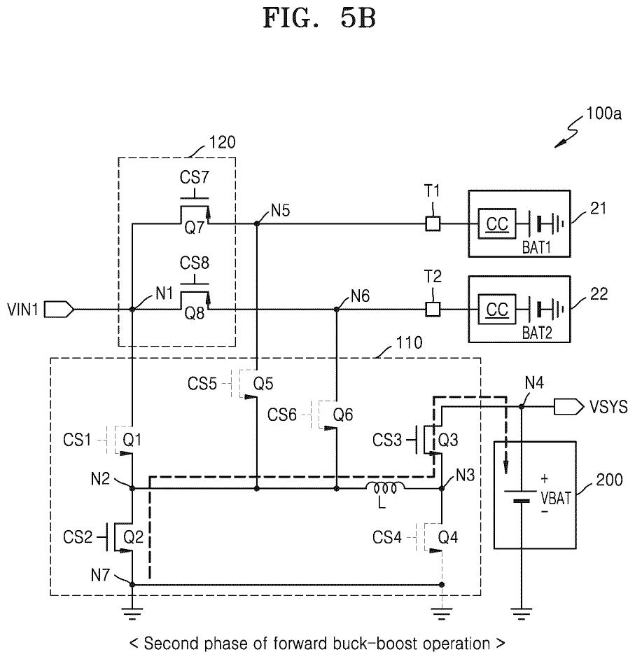

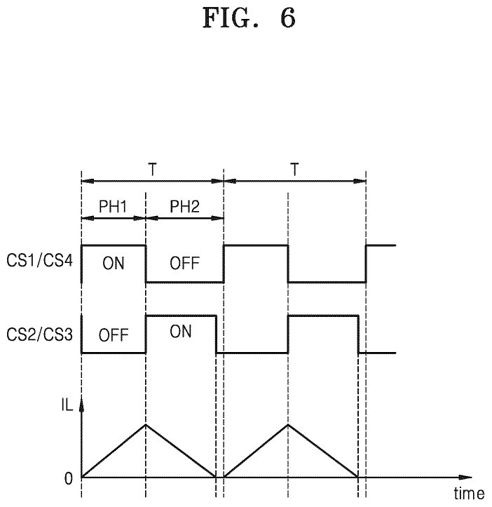

The switching converter 110 may provide external power to the battery 200 through the first power path PP1. Through the switching operation of the first to fourth transistors Q1 to Q4, the switching converter 110 may perform a forward buck-boost operation. In some example embodiments, when performing a forward buck-boost operation, the inductor current IL flowing through the inductor L may flow from the second node N2 to the third node N3. The switching converter 110 may generate the first output voltage VO1 by bucking or boosting the first input voltage VIN1. The on and off times of the first to fourth transistors Q1 to Q4, for example, the duty ratio of the switching converter 110, may be adjusted so that the first output voltage VO1 having the target level is generated. The first output voltage VO1 may be provided to the battery 200 or as a system voltage VSYS to the internal system of the electronic device (10 in FIG. 1). The forward buck-boost operation of the switching converter 110 in the first power mode is described in detail below with reference to FIGS. 5A to 6.

In the first power mode, the seventh and eighth transistors Q7 and Q8 provided in the voltage regulator 120 may be turned on, respectively, to form a second power path PP2 and a third power path PP3 that provide power from the first input voltage VIN1 to the first mobile device 21 and the second mobile device 22, respectively.

The seventh and eighth transistors Q7 and Q8 may generate a fourth output voltage VO4 and a fifth output voltage VO5 by bucking the first input voltage VIN1 in response to the seventh and eighth control signals CS7 and CS8. The seventh and eighth transistors Q7 and Q8 may be controlled depending on the seventh and eighth control signals CS7 and CS8 so that the fourth and fifth output voltages VO4 and VO5 have target levels, respectively.

FIGS. 5A and 5B show forward buck-boost operation of the switching converter, and FIG. 6 is a timing diagram of control signals and inductor current when a switching converter performs forward buck-boost operation.

FIG. 5A shows the first phase PH1 of forward buck-boost operation. Referring to FIG. 6 together, the switching converter 110 may perform a forward buck-boost operation with a cycle, and one cycle T may include a first phase PH1 and a second phase PH2.

The first transistor Q1 and the fourth transistor Q4 may be respectively turned on in response to the first control signal CS1 and the fourth control signal CS4 at an active level, for example, logic high, in the first phase PH1. The second transistor Q2 and the third transistor Q3 may be respectively turned off in response to the second control signal CS2 and the third control signal CS3 at an inactive level, for example, logic low. A first input voltage VIN1 may be provided to the inductor L. The inductor current IL increases by the first input voltage VIN1, and the inductor L may be charged.

Referring to FIGS. 5B and 6, the first transistor Q1 and the fourth transistor Q4 may be respectively turned off in response to the first control signal CS1 and the fourth control signal CS4 at an inactive level, for example, logic low, in the second phase PH2. The second transistor Q2 and the third transistor Q3 may be respectively turned on in response to the second control signal CS2 and the third control signal CS3 at an active level, for example, logic high. The inductor current IL decreases, and the inductor L may be discharged. The energy charged in the inductor L may be transferred to the battery 200 to charge the battery 200. In some example embodiments, when the inductor current IL becomes OA, the second transistor Q2 and the third transistor Q3 may be respectively turned off in response to the second control signal CS2 and the third control signal CS3.

FIG. 7 shows a charging circuit according to an example embodiment operating in a second power mode.

Referring to FIG. 7, when an external power source, for example, the first input voltage VIN1, is not applied to the charging circuit 100a, the charging circuit 100a may operate in the second power mode.

In the second power mode, the voltage regulator 120 does not operate. The seventh transistor Q7 and the eighth transistor Q8 may be turned off in response to the seventh control signal CS7 and the eighth control signal CS8, respectively.

The second to sixth transistors Q2 to Q6 provided in the switching converter 110 perform switching operations in response to the second to sixth control signals CS2 to CS6, thereby forming a fourth power path PP4 and a fifth power path PP5 that provide power from the battery 200 to the first mobile device 21 and the second mobile device 22, respectively. In the second power mode, the first transistor Q1 may be turned off.

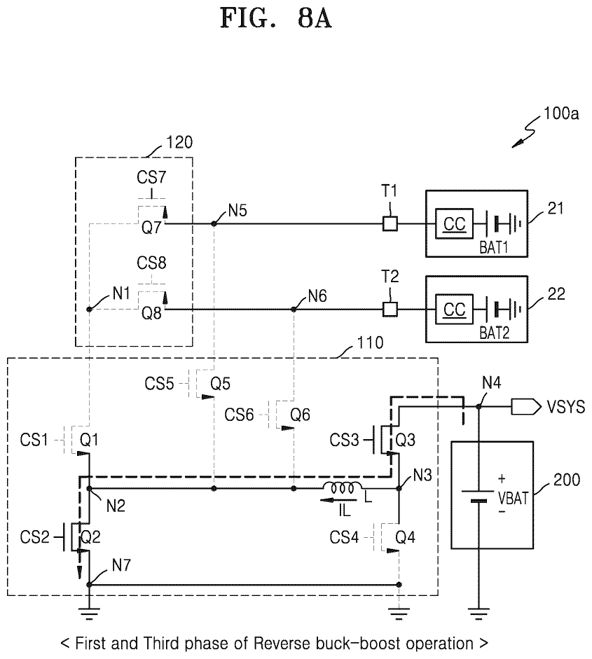

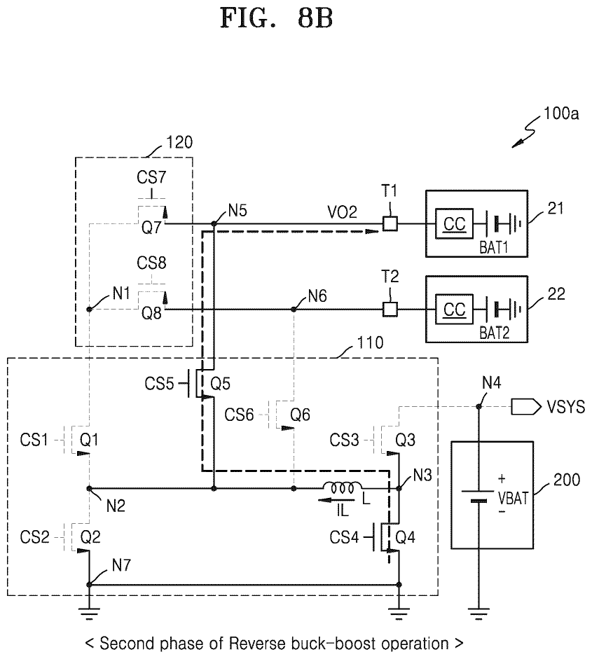

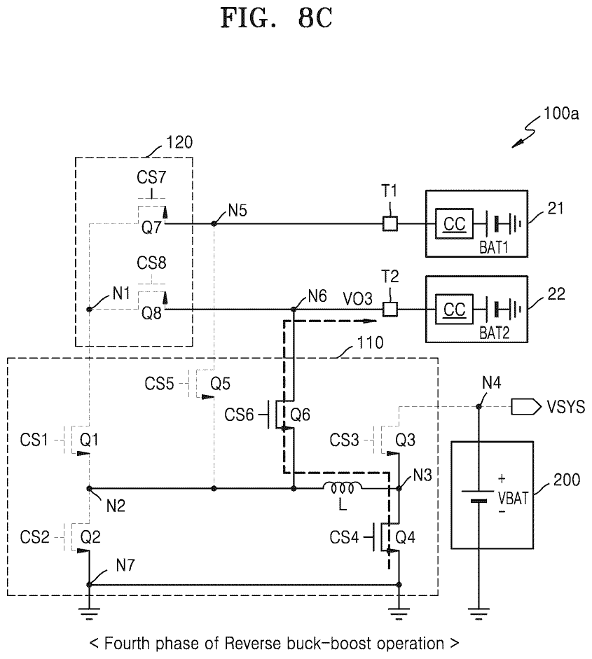

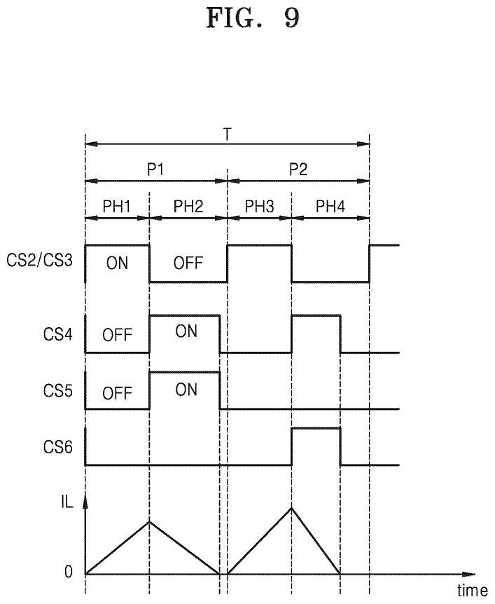

Through the switching operation of the first to sixth transistors Q1 to Q6, the switching converter 110 may perform a reverse buck-boost operation. In some example embodiments, when performing a reverse buck-boost operation, the inductor current IL flowing through the inductor L may flow from the third node N3 to the second node N2. The switching converter 110 may perform bucking or boosting of the second input voltage VIN2 provided from the battery 200 to generate the second output voltage VO2 and the third output voltage VO3, respectively. The on and off times of the second to sixth transistors Q2 to Q6, for example, the duty ratio of the switching converter, may be adjusted so that the second output voltage VO2 and the third output voltage VO3 having the target level are generated. The reverse buck-boost operation of the switching converter 110 in the second power mode is described in detail below with reference to FIGS. 8A to 9.

FIGS. 8A, 8B, and 8C show reverse buck-boost operation of the switching converter, and FIG. 9 is a timing diagram of control signals and inductor current when the switching converter performs a forward buck-boost operation.

Referring to FIGS. 8A to 9, the switching converter 110 may perform a reverse buck-boost operation with a period T including a first period P1 and a second period P2, and the first period P1 and the second period P2 may be alternately repeated. The length of the first period P1 may be the same as the length of the second period P2. In a first period P1, the switching converter 110 may perform a reverse buck-boost operation to generate a second output voltage VO2, and in a second period, the switching converter 110 may perform a reverse buck-boost operation to generate a third output voltage VO3.

FIG. 8A shows the first phase PH1 and the third phase PH3 of reverse buck-boost operation. The second transistor Q2 and the third transistor Q3 may be turned on in response to the second control signal CS2 and the third control signal CS3 at an active level, for example, logic high, in the first phase PH1. The fourth to sixth transistors Q4 to Q6 may be turned off in response to the fourth to sixth control signals CS4 to CS6 at an inactive level, for example, logic low. A second input voltage VIN2 may be provided to the inductor L. The inductor current IL increases by the second input voltage VIN2, and the inductor L may be charged.

FIG. 8B shows the second phase PH2 of reverse buck-boost operation. In the second phase PH2, the second transistor Q2 and the third transistor Q3 may be turned off in response to the second and third control signals CS2 and CS3 at an inactive level, for example, logic low, and the sixth transistor Q6 may be turned off in response to the sixth control signal CS6 at an inactive level. The fourth transistor Q4 and the fifth transistor Q5 may be turned on in response to the fourth and fifth control signals CS4 and CS5 at an active level, for example, logic high. The inductor current IL decreases, and the inductor L may be discharged. The energy charged in the inductor L is transferred to the first mobile device 21, and the battery of the first mobile device 21, for example, the first battery BAT1, may be charged. In some example embodiments, when the inductor current IL becomes OA, the fourth transistor Q4 and the fifth transistor Q5 may be turned off in response to the fourth control signal CS4 and the fifth control signal CS5.

Thereafter, as described with reference to FIG. 8A in the third phase PH3, the inductor L may be recharged by the second input voltage VIN2.

FIG. 8C shows the fourth phase PH4 of reverse buck-boost operation. In the fourth phase PH4, the second and third transistors Q2 and Q3 may be turned off in response to the second and third control signals CS2 and CS3 at an inactive level, and the fifth transistor Q5 may be turned off in response to a fifth control signal CS5 at an inactive level. The fourth transistor Q4 and the sixth transistor Q6 may be turned on in response to the fourth control signal CS4 and sixth control signal CS6 at an active level, for example, logic high. The inductor current IL decreases, and the inductor L may be discharged. The energy charged in the inductor L is transferred to the second mobile device 22, and the battery of the second mobile device 22, for example, the second battery BAT2, may be charged. In some example embodiments, when the inductor current IL becomes OA, the fourth transistor Q4 and the sixth transistor Q6 may be turned off in response to the fourth control signal CS4 and the sixth control signal CS6.

In addition, in order to generate the second and third output voltages VO2 and VO3 having the target level, the on and off times of the second to sixth transistors Q2 to Q6, for example, the duty ratio of the switching converter 110, may be adjusted. For example, the length (e.g., on time) of the first phase PH1 and the length (e.g., off time) of the first phase PH2 within the first period P1 may be adjusted so that the second output voltage VO2 reaches and maintains the target level. In addition, the length of the third phase PH3 (e.g., on time) and the length of the fourth phase PH4 (e.g., off time) within the second period P2 may be adjusted so that the third output voltage VO3 reaches and maintains the target level. For example, the voltage levels of the second output voltage VO2 and the third output voltage VO3 may be sensed, and the on and off times of the second to sixth control signals CS2 to CS6 may be adjusted based on the sensed voltage levels.

In an example embodiment, the duty ratio of the switching converter 110 may be adjusted so that the current provided to the first mobile device 21 and the second mobile device 22, for example, a load current, has a target level. For example, the length of the on-time period within the first period P1 may be adjusted so that the average value of the load current provided to the first mobile device 21 has the target level, and the length of on-time within the second period P2 may be adjusted so that the average value of the load current provided to the second mobile device 22 has the target level. For example, a first load current provided to the first mobile device 21 and a second load current provided to the second mobile device 22 are sensed, respectively, and the on and off times of the second to sixth control signals CS2 to CS6 may be adjusted based on the average value of the first load current and the average value of the second load current over a predetermined period.

As such, in the second power mode, the switching converter 110 performs a reverse buck-boost operation, thereby generating the second output voltage VO2 and the third output voltage VO3 in a time-division manner and also independently generating the second output voltage VO2 and the third output voltage VO3. The switching converter 110 may generate two output voltages using one inductor L, thereby minimizing (or reducing) the increase in BOM of the electronic device (10 in FIG. 1). In addition, because the second output voltage VO2 and the third output voltage VO3 are generated by the switching converter 110 and provided to the first mobile device 21 and the second mobile device 22 without going through the voltage regulator 120, the charging efficiency of the charging circuit 100a in the second power mode may be improved.

In a case where the battery of the first mobile device 21, such as the first battery BAT1, remains fully charged and the battery of the second mobile device 22, such as the second battery BAT2, is repeatedly charged and discharged, when, in the second power mode, the switching converter 110 does not independently generate the second output voltage VO2 and the third output voltage VO3 through the buck-boost operation, but boosts the second input voltage from the battery 200 through a boost operation, and adjusts the boosted voltage to generate the second output voltage VO2 and the third output voltage VO3, the energy of the battery 200 may be wasted due to boosting and bucking to generate the second and third output voltages VO2 and VO3, rather than the energy consumed to charge the first mobile device 21 and the second mobile device 22. Accordingly, the number of times the first mobile device 21 and the second mobile device 22 are charged based on the energy charged in the battery 200 may be reduced.

However, as described above, in the charging circuits 100 and 100a according to an example embodiment, in the second power mode, because the switching converter 110 independently generates the second output voltage VO2 and the third output voltage VO3, energy waste in the battery 200 is reduced and the number of times the first mobile device 21 and the second mobile device 22 are charged may be increased due to the decrease in the energy waste in the battery 200.

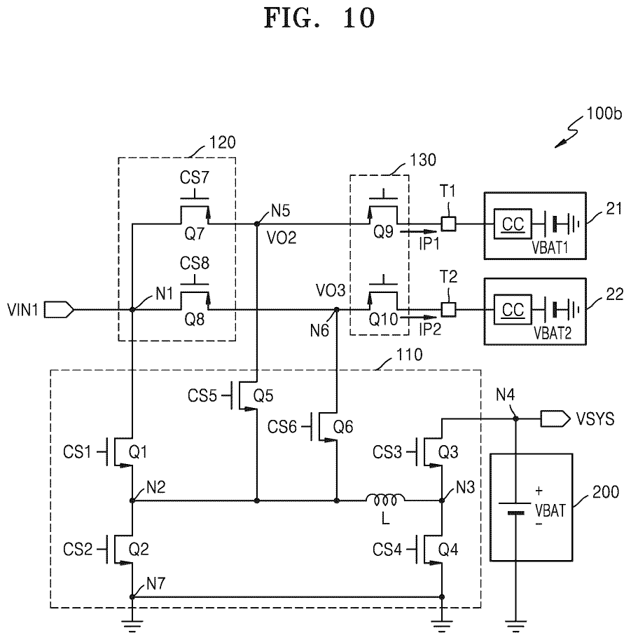

FIG. 10 is a circuit diagram showing a charging circuit according to an example embodiment.

The charging circuit 100b of FIG. 10 is a modification of the charging circuit 100a of FIG. 3, and may be applied as the charging circuit 100 of the electronic device 10 of FIG. 1. Accordingly, the description of the charging circuit 100 and the charging circuit 100a described above may be applied to some example embodiments, and the descriptions already given thereof are omitted.

Referring to FIG. 10, the charging circuit 100b may include a switching converter 110, a voltage regulator 120, and a current sensing circuit 130. Compared to the charging circuit 100a of FIG. 3, the charging circuit 100b may further include a current sensing circuit 130.

The current sensing circuit 130 may include a ninth transistor Q9 connected between the fifth node N5 and the first output terminal T1 and a tenth transistor Q10 connected between the sixth node N6 and the second output terminal T2. The ninth transistor Q9 and the tenth transistor Q10 may be implemented with an N-channel MOSFET or a P-channel MOSFET.

The ninth transistor Q9 may provide a second output voltage VO2 (or a fourth output voltage VO4) output from the voltage regulator 120 in the first power mode or a second output voltage VO2 output from the switching converter 110 in the second power mode to the first output terminal T1 and may sense a current flowing through the first output terminal T1, for example, the first load current IP1.

The tenth transistor Q10 may provide the third output voltage VO3 (or the fifth output voltage VO5) output from the voltage regulator 120 in the first power mode or the third output voltage VO3 output from the switching converter 110 in the second power mode to the second output terminal T2 and may sense a current flowing through the second output terminal T2, for example, the second load current IP2.

In an example embodiment, the ninth transistor Q9 and the tenth transistor Q10 may sense the first load current IP1 and the second load current IP2 using a current mirroring method. For example, the voltages of the gate terminals of the ninth transistor Q9 and the tenth transistor Q10 are provided to the mirroring circuit so that the first load current IP1 and the second load current IP2 may be sensed.

In an example embodiment, the ninth transistor Q9 and the tenth transistor Q10 may operate as voltage regulators, for example, LDOs. The ninth transistor Q9 may adjust the received second output voltage VO2 (or the fourth output voltage VO4) and provide the adjusted voltage to the first mobile device 21. The tenth transistor Q10 may adjust the received third output voltage VO3 (or the fifth output voltage VO5) and provide the adjusted voltage to the second mobile device 22.

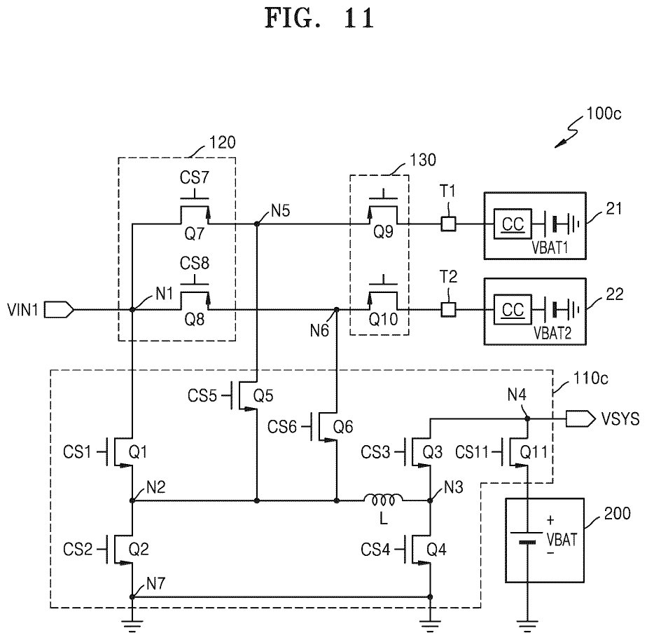

FIG. 11 is a circuit diagram showing a charging circuit according to an example embodiment.

A charging circuit 100c of FIG. 11 is a modified example of the charging circuit 100b of FIG. 10 and may be applied as the charging circuit 100 of the electronic device 10 of FIG. 1. Accordingly, the description of the charging circuits described above (100 in FIG. 1, 100a in FIGS. 3, and 100b in FIG. 10) may be applied to some example embodiments, and the descriptions already given thereof are omitted.

Referring to FIG. 11, the charging circuit 100c may include a switching converter 110c, a voltage regulator 120, and a current sensing circuit 130.

The switching converter 110c may include first to sixth transistors Q1 to Q6 and an eleventh transistor Q11. Compared to the switching converter 110 of FIG. 10, the switching converter 110d may further include an eleventh transistor Q11. The eleventh transistor Q11 may be implemented with an N-channel MOSFET or a P-channel MOSFET. In an example embodiment, the eleventh transistor Q11 may be replaced with a transmission gate.

The eleventh transistor Q11 may be turned on and off based on the 11th control signal CS11. The eleventh transistor Q11 may connect the battery 200 to the switching converter 110a or disconnect the battery 200 from the switching converter 110a. The eleventh transistor Q11 is turned on in the first power mode to connect the battery 200 to the switching converter 110a, and after the battery 200 is fully charged, the eleventh transistor Q11 is turned off to electrically separate the battery 200 from the switching converter 110a.

FIG. 12 is a circuit diagram showing a charging circuit according to an example embodiment.

A charging circuit 100d of FIG. 12 is a modified example of the charging circuit 100c of FIG. 11 and may be applied as the charging circuit 100 of the electronic device 10 of FIG. 1. Therefore, descriptions that overlap with those already given for the charging circuit 100d of FIG. 12 are omitted.

The charging circuit 100d of FIG. 12 may include a switching converter 110c, a voltage regulator 120, a current sensing circuit 130, a sensing circuit 140, and a control circuit 150.

The sensing circuit 140 may sense various voltages VSEN and currents ISEN within the charging circuit 100d. For example, the sensing circuit 140 may sense the inductor current flowing in the inductor L. In an example embodiment, the sensing circuit 140 is connected to the current sensing circuit 130 and may sense the load current provided to the first mobile device 21 and the second mobile device 22. For example, the sensing circuit 140 may include a mirroring circuit that mirrors the current flowing through the ninth transistor Q9 and the tenth transistor Q10.

The sensing circuit 140 may sense the voltage of some nodes of the charging circuit 100d. For example, the sensing circuit 140 may detect the level of the first output voltage by sensing the voltage of the fourth node N4. Additionally, the sensing circuit 140 may determine whether the battery 200 is fully charged. The sensing circuit 140 may detect the levels of the second output voltage and the third output voltage (or the levels of the fourth output voltage and the fifth output voltage) by sensing the voltages of the fifth node N5 and the sixth node N6.

The control circuit 150 may generate control signals of the charging circuit 100d, for example, first to eleventh control signals CS1 to CS11. In an example embodiment, the control circuit 150 may generate first to eleventh control signals CS1 to CS11 based on the voltage and current sensing results of the sensing circuit 140. For example, in the second power mode, when the second and third output voltages generated and output by the switching converter 110c do not reach the target level, the control circuit 150 may adjust the on and off times (e.g., times having active levels and inactive levels) of the second to sixth signals CS2 to CS6 to increase the duty ratio.

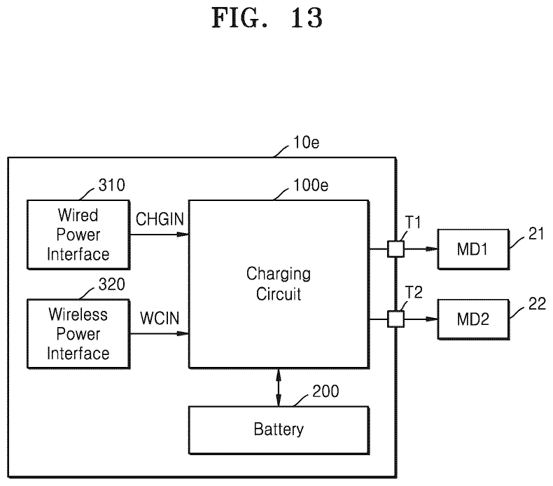

FIG. 13 shows a charging circuit and an electronic device including the same according to an example embodiment. In FIG. 13, a first mobile device 21 and a second mobile device 22 connected to an electronic device 10a are shown together.

Referring to FIG. 13, the electronic device 10e may include a charging circuit 100c, a battery 200, a wired power interface 310, and a wireless power interface 320.

The wired power interface 310 may include a wired power reception circuit. In an example embodiment, the wired power interface 310 may be implemented with a connector. As a non-limiting example, the wired power interface 310 may be implemented with a universal serial bus (USB) connector. The wired power interface 310 may receive the first external voltage CHGIN from a TA or an auxiliary battery device and provide the first external voltage CHGIN to the charging circuit 100c.

The wireless power interface 320 may include a wireless power reception circuit. The wireless power interface 320 may convert a signal received from a wireless power transmission device (e.g., a wireless charging pad) into a second external voltage WCIN and provide the second external voltage WCIN to the charging circuit 100c.

The charging circuit 100e may operate in the first power mode when the first external voltage CHGIN or the second external voltage WCIN is received. As described above, the charging circuit 100e may charge the battery 200 and/or the first mobile device 21 and the second mobile device 22 based on the first external voltage CHGIN or the second external voltage WCIN.

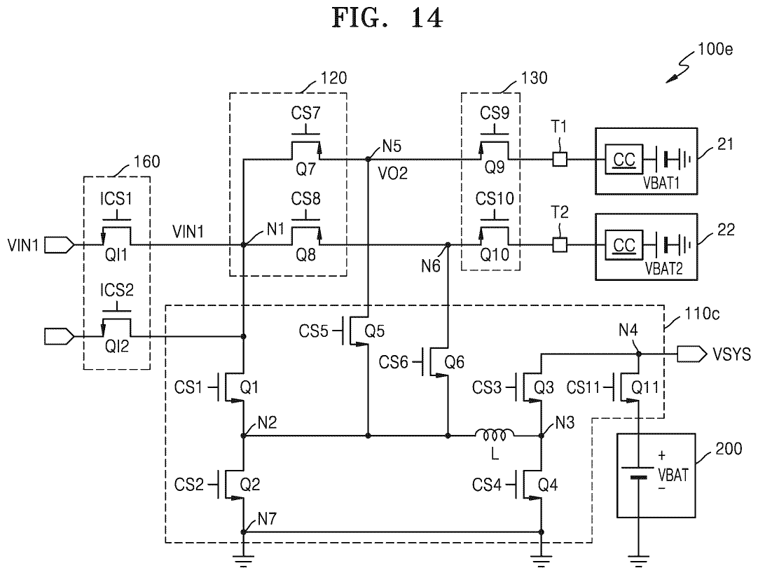

FIG. 14 is a circuit diagram showing a charging circuit according to an example embodiment.

The charging circuit 100e of FIG. 14 may be provided to the electronic device 10c of FIG. 13. The charging circuit 100c of FIG. 14 is a modified example of the charging circuit 100a of FIG. 3 and may be applied as the charging circuit 100 of the electronic device 10 of FIG. 1. The description of the charging circuits 100, 100a, 100b, 100c, and 100d according to the various example embodiments described above may be applied to some embodiments, and the descriptions already given thereof are omitted.

Referring to FIG. 14, the charging circuit 100e may include a switching converter 110c, a voltage regulator 120, a current sensing circuit 130, and an input selection circuit 160. In FIG. 14, the charging circuit 100e is shown as including the switching converter 100c described with reference to FIG. 11, but is not limited thereto. The charging circuit 100e may include another switching converter (e.g., 110 in FIG. 3) described above.

The input selection circuit 160 may provide the first external voltage CHGIN or the second external voltage WCIN as the first input voltage VIN1 to the first node N1. The input selection circuit 160 may include a first input transistor Q11 and a second input transistor Q12, and the first input transistor QI1 and the second input transistor Q12 may be turned on or off in response to the first input control signal ICS1 and the second input control signal ICS2. The first input transistor Q11 and the second input transistor Q12 may be implemented with a P-channel MOSFET or an N-channel MOSFET. However, the input selection circuit 160 is not limited thereto, and the first input transistor QI1 and the second input transistor Q12 may be replaced with a CMOS transistor or a transmission gate.

In the first power mode, the first input transistor Q11 and the second input transistor Q12 may selectively or simultaneously provide the first external voltage CHGIN and/or the second external voltage WCIN as the first input voltage VIN1 to the first node N1.

In the second power mode, the first input transistor QI1 and the second input transistor Q12 may be turned off. In an example embodiment, even if the first external voltage CHGIN and/or the second external voltage WCIN is received from the external power device, the charging device 100e may selectively (selection of system by user or electronic device (10a in FIG. 13)) operate in the second power mode, and the first input transistor QI1 and the second input transistor Q12 may be turned off.

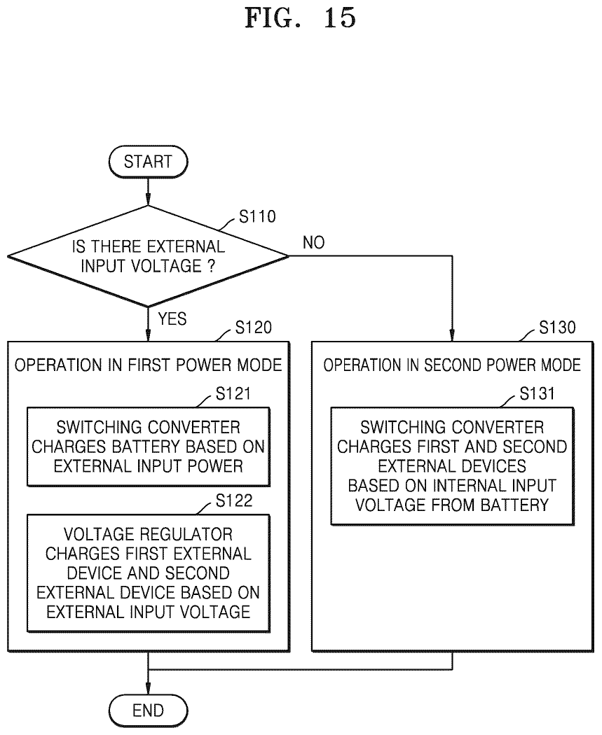

FIG. 15 is a flowchart showing a method of operating an electronic device including a charging circuit according to an example embodiment.

The method of operating the electronic device in FIG. 15 may be performed by the electronic device 10 of FIG. 1 and the electronic device 10e of FIG. 13. The method of operating the electronic device in FIG. 15 is described with reference to FIG. 1. The description of the electronic devices 10 and 10e and the charging circuit 100 described above may be applied to the present embodiment.

Referring to FIG. 15, in operation S110, the electronic device 10 may determine whether there is an external input power source, for example, an external input voltage. For example, the power interface 300 may detect whether external input power is received, and based on the detection result, the electronic device 10 may determine whether there is external input power. In an example embodiment, the electronic device 10 may include a processor that controls the overall operation of the electronic device 10, and the processor may generate a mode signal that determines the operation mode of the charging circuit 100 based on the external input power detection result.

In operation S120, when there is external input power, the charging circuit 100 may operate in a first power mode, for example, an external power mode. The charging circuit 100 may operate in a first power mode based on a mode signal from the processor.

The charging circuit 100 may include a switching converter (110 in FIG. 2) and a voltage regulator (120 in FIG. 2), and in operation S121, the switching converter (110 in FIG. 2) may charge the battery 200 based on external input power. The switching converter 110 may perform boosting or bucking of an external input voltage to generate a first output voltage and provide the first output voltage to the battery 200, thereby charging the battery 200.

The voltage regulator 120 may charge a first external device, such as the first mobile device 21 of FIG. 1 and a second external device, such as the second mobile device 22 of FIG. 1, based on external input power. The voltage regulator 120 may perform bucking of the external input voltage to generate a second output voltage and a third output voltage (or a fourth output voltage and a fifth output voltage) and provide the second output voltage and the third output voltage (or provide the fourth output voltage and the fifth output voltage) to the first external device and the second external device, respectively.

In some example embodiments, operation S121 and operation S122 may be performed simultaneously. In an example embodiment, operation S121 and operation S122 may be performed at different times. As an example, operation S122 may be performed before operation S121. For example, when the first external device and the second external device are charged above a predetermined reference value based on operation S121, operation S122 may be performed. As an example, when the first external device and the second external device are not electrically connected to the charging circuit 100, operation S122 may not be performed and operation S121 may be performed.

In operation S130, when there is no external input power, the charging circuit 100 may operate in a second power mode, for example, an internal power mode. The charging circuit 100 may operate in a first power mode based on a mode signal from the processor.

The switching converter 110 may charge the first external device and the second external device based on the internal input voltage from the battery 200. As described above, the switching converter 110 may include a single inductor, may perform a buck-boost operation on input voltages based on the switching operations of the switching elements using a single inductor to generate a second output voltage provided to the first external device and a third output voltage provided to the second external device in a time-division manner.

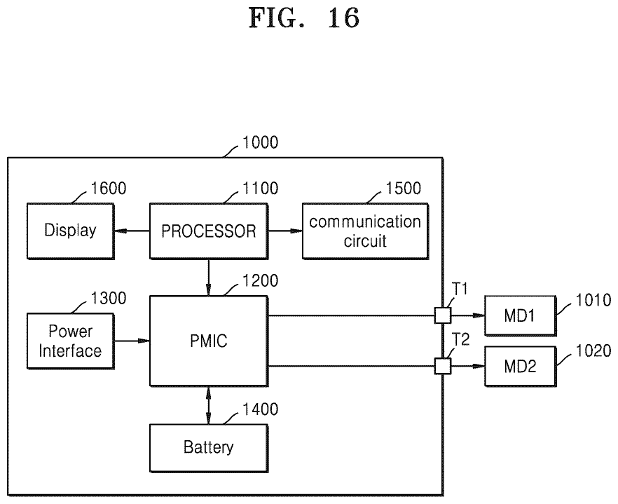

FIG. 16 is a block diagram showing an electronic device according to an example embodiment.

Referring to FIG. 16, an electronic device 1000 may include a processor 1100, a PMIC 1200, a power interface 1300, a battery 1400, a communication circuit 1500, and a display 1600.

The processor 1100 may control the overall operation of the electronic device 1000. The processor 1100 may include a micro control unit (MCU). However, the processor 1100 is not limited thereto and may include a processor such as a central processing unit (CPU).

The processor 110 may control the display 1600 to perform a display operation that displays the charge amount of the battery 1400, the status of the electronic device 1000, etc.

The PMIC 1200 may include a charging circuit (such as 100 in FIG. 1) according to the above-described embodiments. The PMIC 1200 may charge the battery 1400 and/or the first and second mobile devices 1010 and 1020 using external power received through the power interface 1300 in the first power mode. Additionally, the PMIC 1200 may charge the first and second mobile devices 1010 and 1020 using internal power provided from the battery 1400 in the second power mode.

In an example embodiment, the power interface 1300 may detect whether external power is applied and provide a detection result to the processor 1100. The processor 1100 may provide a mode decision signal to the PMIC 1200 based on the detection result. The PMIC 1200 may set the first power mode or the second power mode based on the mode decision signal.

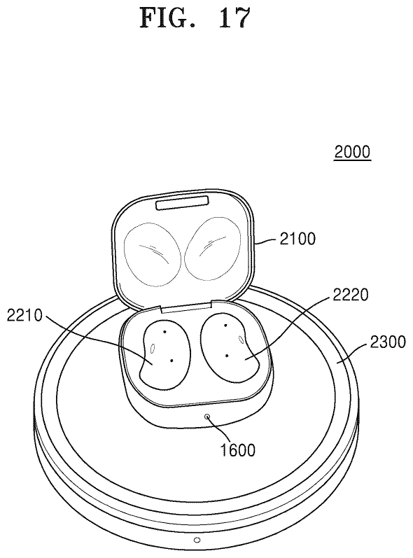

FIG. 17 is a diagram illustrating an electronic system according to an example embodiment.

Referring to FIG. 17, the electronic system 2000 may include an electronic device 2100, first and second mobile devices 2210 and 2220, and a power transmission device 2300.

In some example embodiments, the first and second mobile devices 2210 and 2220 may be wireless earphones or earbuds. The first and second mobile devices 2210 and 2220 may be accommodated in the electronic device 100 and charged.

The electronic device 2100 may be charged by receiving power from an external source, and the first and second mobile devices 2210 and 2220 may be charged based on the charged power. The electronic device 100 may be a charging case or cradle for the first and second mobile devices 2210 and 2220. The electronic device 2100 may accommodate and charge the first and second mobile devices 2210 and 2220. The electronic device 2100 and the first and second mobile devices 2210 and 2220 may be directly connected by wire, for example, through a POGO pin, and the first and second mobile devices 2210 and 2220 may be detachable from the electronic device 2100. In an example embodiment, the electronic device 2100 and the first and second mobile devices 2210 and 2220 are capable of wired and wireless communication, and the status of the first and second mobile devices 2210 and 2220 may be provided to the electronic device 2100 through wired or wireless communication. In an example embodiment, firmware included in the electronic device 2100 may be updated through wired or wireless communication with at least one of the first and second mobile devices 2210 and 2220.

The electronic device 100 of FIG. 1 and the electronic device 100e of FIG. 13 described above may be provided as the electronic device 2100. The electronic device 2100 may include a battery (200 in FIG. 1) and/or a charging circuit (100 in FIG. 1) that charges the first and second mobile devices 2210 and 2220 based on external power provided from outside or internal power provided from a battery. The charging circuit 100 may include the switching converter (110 in FIG. 2) and the voltage regulator (120 in FIG. 2) including a single inductor. In the second power mode operating based on internal power from the battery 200, the switching converter 110 may generate a second output voltage and a third output voltage in a time-division manner using a single inductor and provide the second and third output voltages to the first and second mobile devices 2210 and 2220, respectively. As the switching converter 110 independently generates the second output voltage and the third output voltage, charging efficiency may be improved. In addition, because the switching converter 110 generates the second and third output voltages using a single inductor, an increase in the BOM of the electronic device 2100 can be minimized (or reduced).

The power transmission device 2300 may be a wireless charging pad. The power transmission device 2300 may be connected to an external power source and provide power to the electronic device 2100. The power transmission device 2300 may convert external power into an electrical signal and provide the converted electrical signal to the electronic device 2100. In an example embodiment, the power transmission device 2300 may be a TA or an auxiliary battery.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While inventive concepts have been particularly shown and described with reference to embodiments thereof, it will be understood that various changes in form and details may be made therein without departing from the spirit and scope of the following claims.

1. A charging circuit comprising:
a buck-boost converter circuit configured to
convert a first input voltage received at a first node into a first output voltage to charge a battery based on the first output voltage and
time-divisionally convert a second input voltage provided from the battery into a second output voltage provided to a first external device and a third output voltage provided to a second external device; and
a voltage regulator circuit configured to adjust the first input voltage to generate a fourth output voltage and a fifth output voltage,
wherein the voltage regulator is configured to provide the fourth output voltage to the first external device and the fifth output voltage to the second external device in response to the charging circuit operating in a first power mode, and
wherein the buck-boost converter circuit is configured to provide the second output voltage to the first external device and the third output voltage to the second external device in response to the charging circuit operating in a second power mode.

2. The charging circuit of claim 1, wherein the buck-boost converter circuit comprises
an inductor; and
a plurality of switching elements configured to control current flowing in the inductor.

3. The charging circuit of claim 2, wherein the plurality of switching elements comprise
a first transistor connected between the first node and a second node to which a first terminal of the inductor is connected;
a second transistor connected between the second node and a seventh node;
a third transistor connected between a third node and a fourth node to which a second terminal of the inductor is connected, and the third transistor being configured to output the first charging voltage to the fourth node or receive the second input voltage from the fourth node;
a fourth transistor connected between the third node and the seventh node;
a fifth transistor connected between the second node and a fifth node and the fifth transistor being configured to output the second output voltage to the fifth node; and
a sixth transistor connected between the second node and a sixth node and the sixth transistor being configured to output the third output voltage to the sixth node.

4. The charging circuit of claim 1, wherein the buck-boost converter circuit is configured to
convert the first input voltage into the first output voltage in response to receiving the first input voltage from an external power source, and
convert the second input voltage provided from the battery into the second output voltage and the third output voltage in response to blocking reception of the first input voltage from the external power source.

5. The charging circuit of claim 1, wherein the buck-boost converter circuit is configured to
generate the second output voltage in a first period and the third output voltage in a second period consecutive to the first period, wherein the first period and the second period alternate, and a length of the first period is equal to a length of the second period.

6. The charging circuit of claim 1, wherein the voltage regulator circuit comprises
a seventh transistor connected between the first node and a fifth node; and
an eighth transistor connected between the first node and a sixth node.

7. The charging circuit of claim 6,
wherein the seventh transistor is configured to generate the fourth output voltage by bucking the first input voltage and the seventh transistor is further configured to output the fourth output voltage to the fifth node, and
wherein the eighth transistor is configured to generate the fifth output voltage by bucking the first input voltage and the eight transistor is further configured to output the fifth output voltage to the sixth node.

8. The charging circuit of claim 6,
wherein the seventh transistor and the eighth transistor are configured to be turned on in response to receiving the first input voltage from an external power source, and
wherein the seventh transistor and the eighth transistor are configured to be turned off in response to a reception of the first input voltage from the external power source being blocked.

9. The charging circuit of claim 1, further comprising
a ninth transistor configured to provide the second output voltage or the fourth output voltage to a first output terminal and the ninth transistor is further configured to sense a current flowing through the first output terminal; and
a tenth transistor is configured to provide the third output voltage or the fifth output voltage to a second output terminal and the tenth transistor is further configured to sense a current flowing through the second output terminal.

10. The charging circuit of claim 1, further comprising
a first input transistor configured to provide a first external voltage received through a wired connection from a first external power source as the first input voltage; and
an input selection circuit including a second input transistor configured to provide a second external voltage received through a wireless connection from a second external power source as the second input voltage.

11. An electronic device comprising:
a battery; and
a charging circuit configured to charge at least one of the battery and a plurality of external devices based on a first input voltage received from outside, and the charging circuit is further configured to charge the plurality of external devices based on a second input voltage from the battery,
wherein the charging circuit comprises
a switching converter circuit configured to
generate a plurality of output voltages using a single inductor,
convert the first input voltage into a first output voltage provided to the battery in a first power mode, and
convert the second input voltage from the battery into a second output voltage and a third output voltage provided to each of a first external device and a second external device, respectively, in a second power mode; and
a voltage regulator circuit configured to adjust the first input voltage in the first power mode to generate a fourth output voltage and a fifth output voltage, and
wherein the voltage regulator is configured to provide the fourth output voltage to the first external device and the fifth output voltage to the second external device in response to the charging circuit operating in the first power mode.

12. The electronic device of claim 11, wherein the switching converter circuit comprises
an inductor; and
a plurality of switching elements configured to control current flowing in the inductor,
wherein, in the second power mode, the inductor and the plurality of switching elements are configured to perform a buck-boost operation to generate the second output voltage in a first period and generate the third output voltage in a second period consecutive to the first period, and
wherein the first period is same as the second period.

13. The electronic device of claim 12, wherein the plurality of switching elements comprise
a first transistor connected between a first node and a second node to which a first terminal of the inductor is connected;
a second transistor connected between the second node and a seventh node;
a third transistor connected between a third node to which a second terminal of the inductor is connected and a fourth node and the third transistor is configured to output the first charging voltage to the fourth node or receive the second input voltage from the fourth node;
a fourth transistor connected between the third node and the seventh node;
a fifth transistor connected between the second node and a fifth node and the fifth transistor being configured to output the second output voltage to the fifth node; and
a sixth transistor connected between the second node and a sixth node and the sixth transistor being configured to output the third output voltage to the sixth node.

14. The electronic device of claim 13, wherein the voltage regulator circuit comprises
a seventh transistor connected between the first node and the fifth node; and
an eighth transistor connected between the first node and the sixth node.

15. The electronic device of claim 14, wherein the eighth transistor is configured to
generate the fourth output voltage by bucking the first input voltage and output the fourth output voltage to the fifth node, and
generate the fifth output voltage by bucking the first input voltage and output the fifth output voltage to the sixth node.

16. The electronic device of claim 11, further comprising
a processor configured to generate a mode signal indicating one of the first power mode and the second power mode based on whether the first input voltage is received from outside, and the processor is further configured to provide the mode signal to the charging circuit.

17. The electronic device of claim 11, further comprising a power interface configured to receive the first input voltage from outside.

18. The electronic device of claim 17, wherein the power interface comprises
a wired power interface including a wired power receiving circuit; and
a wireless power interface including a wireless power reception circuit.

19. The electronic device of claim 11,
wherein the first external device and the second external device each include wireless earphones, and
wherein the electronic device includes a charging case for the wireless earphones.

20. A method of operating an electronic device including a battery and a charging circuit for charging the battery, the method comprising:
detecting whether there is an external input power received from outside;
operating in a first power mode based on the external input power when the external input power is provided; and
operating in a second power mode based on internal input power provided from the battery when the external input power is not provided,
wherein, in the first power mode, a buck-boost converter circuit provided in the charging circuit is configured to generate a first output voltage provided to the battery based on the external input power, and a voltage regulator circuit provided in the charging circuit is configured to generate a fourth output voltage and a fifth output voltage provided to a first external device and a second external device, respectively, based on the external input power, and
wherein, in the second power mode, the buck-boost converter circuit is configured to generate a second output voltage and a third output voltage based on the internal input power.

21.-24. (canceled)
